(19) United States
(12) Patent Application Publication
(10) Pub. No.: US 2004/0083284 A1
(43) Pub. Date: Apr. 29, 2004

(54) System and method for providing data awareness across multiple domains

(76) Inventors: Yuval Ofek, Waltham, MA (US); Kevin Shea, Boxboro, MA (US); Charles Hudson, Haverhill, MA (US); Andrew List, Reading, MA (US); David Pinkney, Watertown, MA (US); George Iglesias, Arlington, MA (US)

Correspondence Address: LAHIVE & COCKFIELD, LLP., 28 STATE STREET, BOSTON, MA, 02109, US

(21) Appl. No.: 10/280,204

(22) Filed: Oct. 25, 2002

(51) Int. Cl. G06F 15/173

(52) U.S. Cl. 709/224

(57) ABSTRACT

A method of tracking the movement of data between data centers through different types of domains is disclosed. Network topologies are dynamically determined and objects corresponding to elements in the domains (entity objects) are stored in a Topology Object Model. The details of the elements stored include both physical and logical connections to other elements in the domain. Elements are cross-referenced with other elements using entity objects associated with the elements. A change in the status of an element is recorded in the corresponding entity object and in the entity objects of the cross-referenced elements. The information contained in the Topology Object Model is graphically presented to a user by displaying depictions of the physical or logical connections and datapaths used in data movement across the multiple domains.

### FIELD OF THE INVENTION

The illustrative embodiment of the present invention relates generally to tracking conditions and elements associated with data movement in a networked environment and more particularly to providing data awareness of data transmitted between data centers across multiple types of domains.

### BACKGROUND

A number of network and device management tools have been developed to manage and operate networks and devices located on networks. The device management tools frequently provide a remote management capability that enables a user to oversee and direct the operation of the device from a remote location over a network. Similarly, network management tools frequently enable the monitoring and configuration of a network from a single central location. The device management tools may work in conjunction with network management tools that are using the same communication protocol.

A domain is a group of computers or devices on a network with common rules and procedures. The domain is administered as a unit and utilizes a common technology and protocol for communication between elements within the domain (i.e. a domain may be SONET-based (Synchronous Optical Network), SAN-based (Storage Area Network-based), etc.). Companies which have distributed operations over wide areas frequently have different types of domains as part of a single company wide network. As used herein, the term domain also encompasses groupings of non-computer devices such as a domain of optical switches and connecting fiber optic cables, in addition to environments where the domain elements include computers.

Unfortunately, most existing network and device management tools are designed to work only within a single domain at a time. For example, a network management tool, may be designed to work in a SONET-based domain but not in a DWDM-based (Dense Wave Division Multiplexing-based) domain. Data may be transported long distances from one location originating in an IP/Ethernet-based domain, travel through a server-based domain, and then be forwarded to a destination storage-based domain. Each of these particular domains may have a separate management tool associated with the domain. Conventionally however, the management tools for each domain are not configured to work in conjunction with other tools for other types of domains. For example, server-based domain management tools are not designed to work with storage-based domain tools. Those cross-domain management tools which do exist focus on actions like event consolidation rather then tracking data across datapaths spanning multiple types of domains.

### SUMMARY OF THE INVENTION

The illustrative embodiment of the present invention provides a method of tracking data between data centers in environments including multiple types of domains. Data is tracked across both physical and logical connections. Network topologies are dynamically determined and elements in the domains are stored in a Topology Object Model. Each element of the domain has an associated collection of entity objects which store details about the element. The details of the element stored include both physical and logical connections to other elements in the domain. Elements may be cross-referenced with logical connections, physical connections, other elements, and applications in the element's associated entity object. A change in the status of an element is reflected in the entity objects of all of the cross-referenced items. The information contained in the Topology Object Model may be graphically presented to a user by displaying depictions of the physical or logical connections used in data movement across multiple domains.

In one embodiment, a networked system includes a number of different types of domains. Data is moved between data centers across the multiple types of domains. The data centers are a collection of core information in the enterprise combined with the intelligence to process the information. The data flow between the data centers is automatically monitored and the logical connections used by the data flow are stored.

In another embodiment, a networked system includes a number of different types of domains. Data is moved between data centers across the multiple types of domains. Each domain has a number of different elements. The elements in the various domains are programmatically identified and then modeled with corresponding entity objects. The entity objects are used to store information about the element and the logical connections used by the element to transmit data. The entity objects are stored in a Topology Object Model.

In a different embodiment, a networked system for providing cross-domain 5 awareness includes a number of different electronic devices for transmitting and receiving data across a number of different domains. The domains include at least two of a SONET-based domain, a DWDM-based domain, a SAN-based domain, a server-based domain, a storage-based domain, a Channel Extension-based domain, a mainframe-based domain, an application-based domain, and an IP/Ethernet-based domain. The system also includes a Topology Object Model which holds entity objects corresponding to elements in the various domains. Data is transmitted between electronic devices via the elements in the domains. The Topology Object Model programmatically determines the logical connections used by the data flow. The logical connections are recorded in entity objects corresponding to elements used in the data flow.

In an embodiment, a networked system includes a number of different types of domains, each having a number of elements. Separate entity objects correspond to and hold information about each identified element in the domains. The entity objects store information about the logical connections used for data flow between the elements in the domains. A Topology Object Model is used to store the entity objects. The system associates an application element with at least one datapath and stores a reference to the association in entity objects for both elements.

In another embodiment, a networked system includes a number of different types of domains each with a number of elements. The system includes a number of data centers transmitting and receiving data across the domains. The elements in the different domains are identified and corresponding entity objects for each element store information about the element including indications of datapaths used for data flow between the data centers. The entity objects are stored in a Topology Object Model.

### BRIEF DESCRIPTION OF THE DRAWINGS

FIG. 1 depicts an environment suitable for practicing an illustrative embodiment of the present invention;

FIG. 2A depicts a block diagram of data flow between data centers across different types of domains;

FIG. 2B depicts a block diagram of the logical connections between elements in different types of domains;

FIG. 3 is a flowchart of the sequence of steps followed by the illustrative embodiment of the present invention to identify elements and the logical and physical connections between elements;

FIG. 4 depicts a block diagram of a domain element record containing information on a SAN-based domain element, a SAN switch;

FIG. 5 is a flowchart of the sequence of steps used to determine the status of an intelligent element in one of the domains of the illustrative embodiment of the present invention;

FIG. 6 is a flowchart of the sequence of steps followed by the illustrative embodiment of the present invention to determine the status of a non-intelligent element in one of the domains of the illustrative embodiment of the present invention and the updating of other elements associated with the non-intelligent element;

FIG. 7 depicts a block diagram of the connectivity object heirarchy of connectivity objects used by the entity object;

FIG. 8 depicts a block diagram of a connectivity element; and

FIG. 9 is a flowchart of the sequence of steps followed by the illustrative embodiment of the present invention to dynamically extend circuits.

### DETAILED DESCRIPTION

The illustrative embodiment of the present invention provides a method of tracking the movement of data between data centers through different types of domains. Network topologies are dynamically determined and objects corresponding to elements in the domains (entity objects) are stored in a Topology Object Model. The details of the elements stored include both physical and logical connections utilized by the elements and datapaths to other elements in the domain. Entity objects are cross-referenced with objects representing other physical, logical and connectivity elements. A change in the status of an element is recorded in an associated entity object and in the entity objects of cross-referenced elements. The information contained in the Topology Object Model is graphically presented to a user by displaying depictions of the physical and logical connections and datapaths used in data movement across multiple domains.

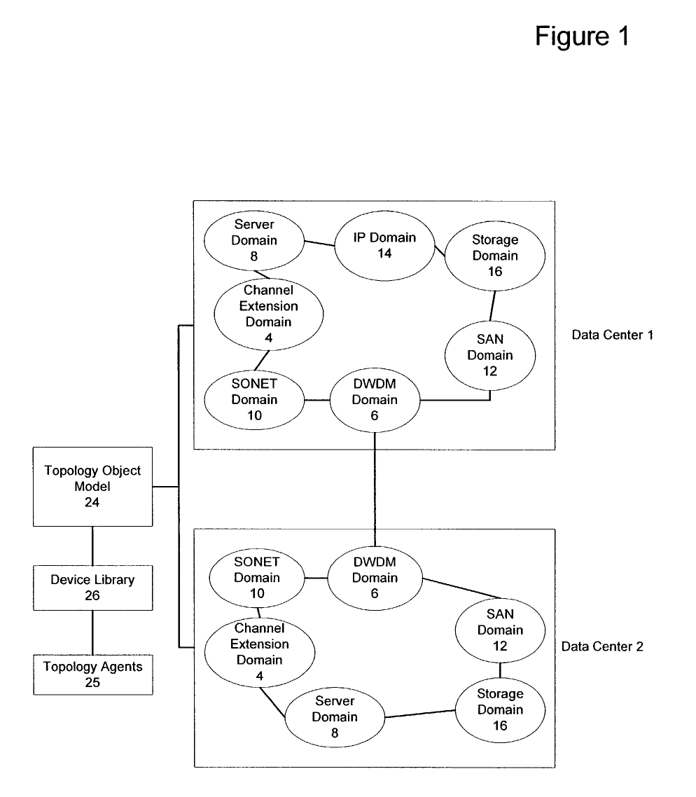

FIG. 1 depicts an environment suitable for practicing an illustrative embodiment of the present invention. The illustrative embodiment of the present invention tracks the movement of data between data centers 1 and 2 across different types of domains. The different types of domains navigated by the data include domains such as a channel extension-based domain 4, a DWDM-based domain 6, a Server-based domain 8,, a SONET-based domain 10, and a SAN-based domain 12. Additional types of domains traversed by the data include an IP/Ethernet-based domain 14 and a storage-based domain 16. Those skilled in the art will recognize that the data may be tracked across other types of domains without departing from the scope of the present invention.

The elements of the various domains are individually modeled with entity objects stored in a Topology Object Model 24. There are three types of elements modeled by the illustrative embodiment of the present invention, physical elements, logical elements and connectivity elements. Physical elements represent objects that occupy physical space. The physical elements represent any component of a system that has a physical identity such that it can be touched or seen such as a switch or a network interface card. Logical elements represent abstractions used to manage, configure and coordinate aspects of the physical and software environment. For example, logical elements may represent systems, system components or system capabilities. Connectivity elements represent abstractions used to capture connectivity aspects (within or between elements) of the physical environment or software environment (e.g. applications). For example, connectivity elements may represent the datapaths among and through the domains and the underlying domain components.

The Topology Object Model 24 receives information collected by one or more topology agents 25. The topology agents 25 are executable software processes which are used to dynamically determine domain elements and determine element status. Those skilled in the art will recognize that separate agents may be used for the element determination process and the status determination process. Both the entity objects and the Topology Object Model 24 are discussed in more detail below. The topology agents are instructed to collect data by one or more device libraries 26 which are also interfaced with the Topology Object Model 24. The device library 26 holds information about the elements and connections used in the various domains. The illustrative embodiment of the present invention models the various elements of the different types of domains and presents a graphical depiction of the data movement across physical and logical connections between elements. The data flow may also be illustrated at the application layer.

Different types of domains utilize different elements and protocols. One or more device libraries 26 are used to store a record of the different elements and element characteristics that are used to transfer data in each domain. Device types and characteristics, physical and logical connections for devices, transmission medium types and characteristics, and similar information is used by the Topology Object Model 24 to model cross-domain data flow. The stored information is different for each domain. For example, a SONET-based domain includes switches and transport mechanisms as elements. An IP/ethernet domain may use category 5 cable (Cat5) and an IP addressing model. A DWDM-based domain uses fiber optic cable and multiplexed signals traveling at different wavelengths over the cable to transmit data. A SAN-based domain includes elements representing the shared storage devices and transport mediums connecting the shared storage device to the network. A SAN-based domain includes elements used in the transfer of data between mainframes, supercomputers, desktop computers and storage devices. The Topology Object Model 24 uses the information stored in the device library 26 to model the switches, ports and links that make up a fabric of switches used in a domain, as well as the connections crossing the switches.

The Topology Object Model 24 provides a normalized representation of the physical and logical connections and datapaths across domains of the various elements.

The underlying provisioned datapaths and their interconnectivity form the foundation of the topology framework. The framework allows for circuit traversals representing application datapaths to run over the framework. There is a bi-directional association between the logical element and its connectivity realization which allows the object model to move between element connectivity and application datapaths. Thus the model allows for the capture of all of the datapaths utlized in SONET over DWDM by modeling the underlying DWDM elements including the optical fiber, the multiple wavelengths of the DWDM signal on the fiber and the multiplexed OC signals carried on the individual wavelengths.

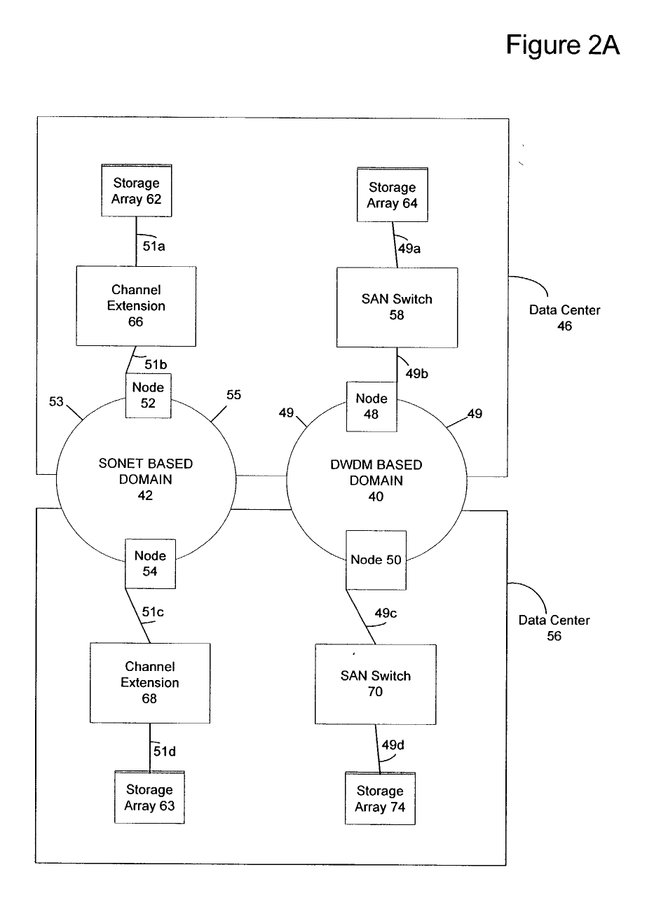

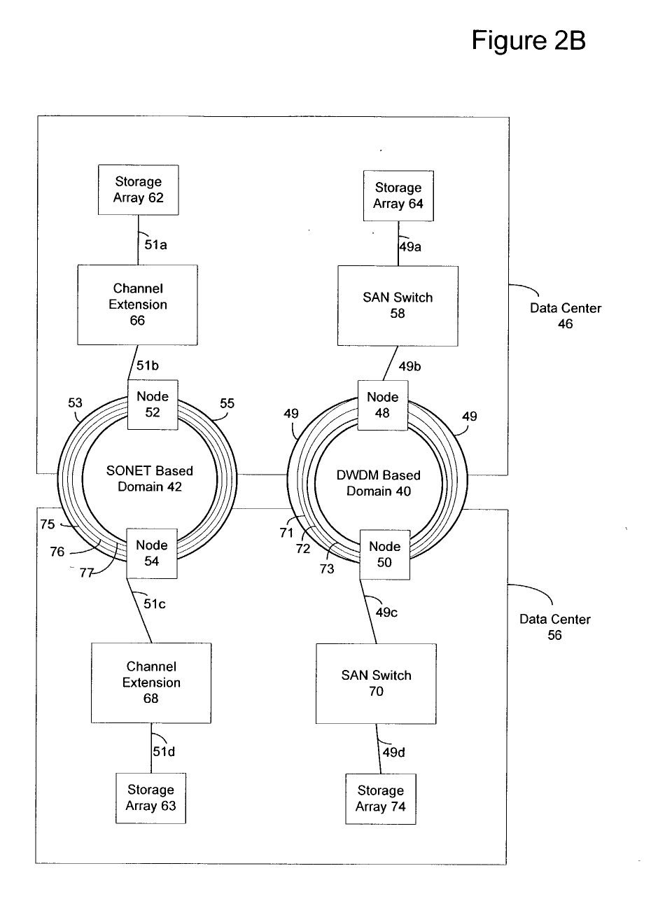

The information stored in the Topology Object Model 24 is used to generate graphical representations of the data flow between domains. FIG. 2A is a block diagram of a graphical representation of the physical connections used to transmit data between data centers across two adjacent domains generated from data stored in the Topology Object Model 24. The graphical representation allows a user to track the movement of data across physical elements within the domains. Data centers 46 and 56 are connected across two different types of domains, a DWDM-based domain 40 and a SONET-based domain 42. The DWDM-based domain 40 includes optical fibers 49 connecting a node 48 and a node 50. The node 48 is interfaced with a node 58 in a SAN-based domain. The node 50 is also interfaced with a node 70 in a SAN-based domain. Storage Arrays 64 and 74 are interfaced with the SAN nodes 58 and 70. All of these interfaces include optical fiber connections (49a-49d). The SONET-based domain 42 includes nodes 52 and 54 connected by a fiber ring made up of two segments of optical fiber 53 and 55 connecting the nodes 52 and 54. The ring may be a uni-directional or bi-directional ring. The nodes 52 and 54 are interfaced with channel extension devices 66 and 68, each of which are interfaced with storage arrays 62 and 63. These channel extension and storage interfaces utilize optical fiber and electrical connections (51a-51d). Those skilled in the art will recognize that additional elements contained within the domains may also be depicted without departing from the scope of the present invention.

The data contained within the Topology Object Model 24 may also be used to generate depictions of the logical connections used by the data flow between data centers across different types of domains. FIG. 2B depicts a block diagram of a graphical representation of the individual datapaths used to transmit data between the data centers and across the two adjacent domains of FIG. 2A. The DWDM based domain 40 includes two nodes 48 and 50 connected by the optical fiber 49. Also shown are three datapaths 71 and 72 and 73 representing wavelengths within the optical fiber 49. In the SONET-based domain 42, optical fibers 53 and 55 connect the nodes 52 and 54. The datapathways 75, 76 and 77 inside the optical fiber 53 are shown representing STS ranges (Synchronous Transport Signal ranges) within the fiber. Either physical connection or logical connection information from the Topology Object Model 24 may be displayed either programmatically or in response to a user's specific request. The illustrative embodiment of the present invention may show varying amounts of logical information to a user. For example, end to end datapaths between data centers, portions of datapaths, or logical connections for a specific device, or some other subset or grouping of connectivity information, may be displayed to a user.

Prior to tracking data movement across the multiple domains, the topology of the domains must first be determined. The illustrative embodiment of the present invention models each element in the multiple domains by storing information about the element in a collection of corresponding objects. Each collection of entity objects is stored in a Topology Object Model 24 of the overall environment. Intelligent elements in the domains respond to registration requests with acknowledgments and identifying information. A device library 26 of different types of elements used in particular domains and their associated characteristics is consulted to determine non-intelligent connections between elements. For example, the terminals in a DWDM based domain may respond to a registration request, but the optical fiber connecting the terminal does not respond to a registration request. In such a case, the device library 26 of DWDM devices would indicate that the terminals are connected by an optical fiber and an optical fiber element would be identified as connecting the 2 terminals despite the lack of response from the actual element. An optical fiber connection is added to the entity objects associated with each terminal. Physical links and attributes for non-intelligent elements are provided by a system user. A collection of new entity objects is created for the non-intelligent element (i.e.: the optical fiber) and the attributes for the optical fiber are supplied from data retrieved from the appropriate domain device library 26 and/or a query to a system user. Similarly, the Topology Object Model 24 leverages the device library 26 containing device characteristics to determine the logical and physical connections connecting each intelligent element in the multiple types of domains. Characteristics relating to data transfer such as the capacity and number of available channels in a SONET ring, or the available bandwidth in a DWDM fiber may be stored as additional information in the entity objects.

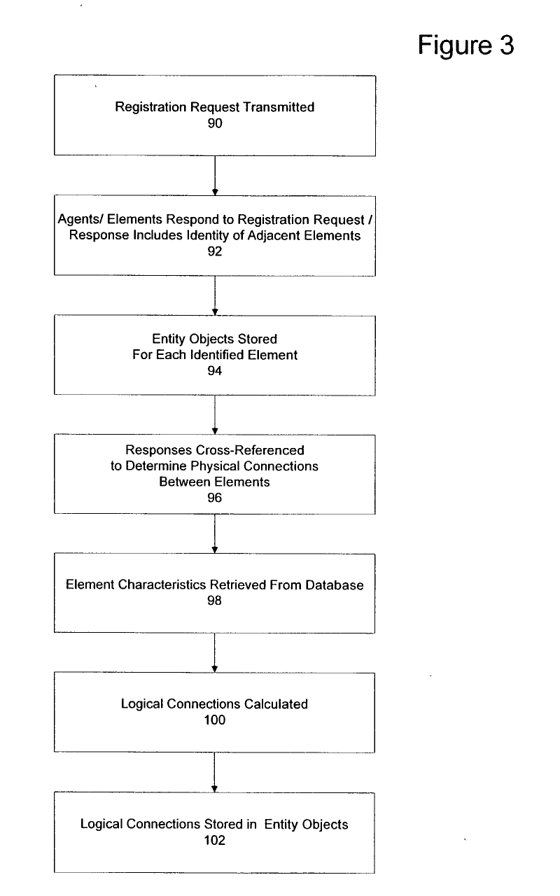

FIG. 3 depicts the sequence of steps followed by the illustrative embodiment of the present invention to identify elements in the multiple domains. The sequence begins with a registration request transmitted in the various domains (step 90). The registration request solicits responses from intelligent elements. The registration request may be made using any of a number of different service and device discovery protocols including SNMP (Simple Network Mail Protocol) and TL1 (Transaction Language 1). The registration requests are sent out over the networks used to transmit data between the data centers. The various elements (or agents for the elements) respond to the registration request. The response may include the identity of any adjacent elements of which the responding element is aware (step 92). A collection of entity objects is created and stored for each responding and identified element (step 94). The various responses may be cross-referenced to determine physical connections between responding elements (step 96). For example, if optical switch A responds that it is adjacent to optical switch B, and optical switch B responds that it is adjacent to optical switch A and optical switch C, and optical switch C responds that it is adjacent to optical switch B and optical switch D, it may be determined that optical switch B is located between optical switch A and optical switch C and connected to both by an optical fiber (since the device library 26 indicates that optical switches are connected to other optical switches using optical fiber).

The characteristics of the various responding elements are retrieved from the device library 26 providing logical connectivity data (step 98). The logical connections between elements are calculated based on the characteristics (step 100) and stored in the various entity objects (step 102). By way of the above-example, if optical switch C is a DWDM switch, the device library 26 may indicate that a single optical fiber connecting optical switch C to optical switch D contains 5 available channels that may be used as separate datapaths between the two switches. Alternatively, if the optical switch C is a SONET node in a four fiber BLSR (Bi-directional Line Switched Ring), the device library 26 indicates that there is only 50% of the fiber bandwidth available because two of the optical fibers are reserved for protection. Available datapaths between points in a domain are modeled as connectivity elements and may be associated with other physical and logical elements through their corresponding entity objects. For example, an application object may be cross-referenced to a datapath object. By binding the application to the datapath (which may cross multiple types of domains), changes in the datapath may be automatically reflected in the application object.

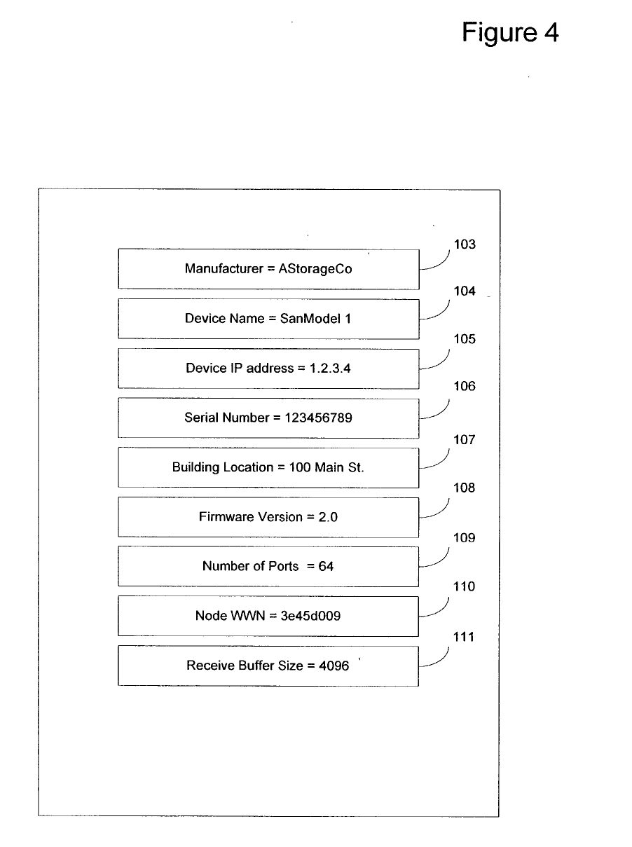

FIG. 4 depicts an entity object stored in the Topology Object Model 24 that describes element characteristics of a SAN switch. The attributes that are of interest are accessed from the Device Library 26 and then the values of those attributes are gathered from the Topology Agents 25 and stored in the Topology Object Model 24. The record includes the manufacturer 103, the Device Name 104, the Device IP address 105. Other attributes include Serial Number 106, Building Location 107, Firmware Version 108, Number of Ports 109, Node WWN 110, and Receive Buffer Size 111 The user specifies values for attributes such as Building Location 107 that cannot be discovered by the Topology Agents.

Each collection of entity objects includes references to multiple other elements in the Topology Object Model. The references may be to other elements utilized in data transmission, applications associated with the particular element, physical connections or attributes utilized by the particular element, and other similar information. A change in status to an element is recorded in an entity object and also updated in all of the referenced objects. In this manner, the failure of an element in a SAN-based domain may cause the updating of the status of a datapath that traverses the failed element as part of a path crossing multiple domains.

Once the topology of the various domains has been determined, the illustrative embodiment of the present invention uses the information contained within the Topology Object Model 24 to update elements and connections across multiple domains in response to changing conditions. Entity objects associated with an element hold references to datapaths and other elements through their corresponding entity objects. Dynamically determined changes in status in an element are used to update connectivity information across domains.

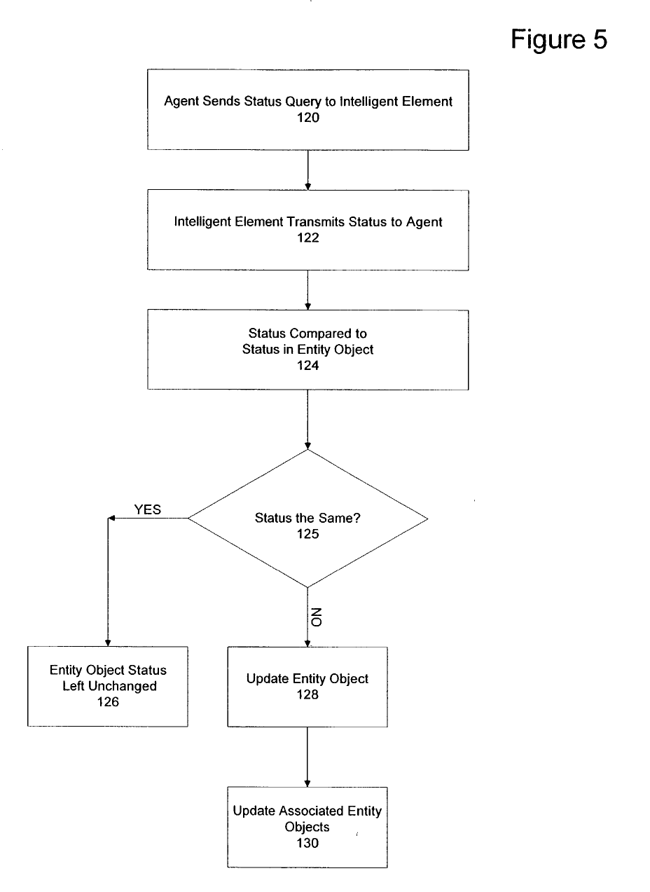

FIG. 5 depicts the sequence of steps followed by the illustrative embodiment of the present invention to determine an updated status for an intelligent element capable of responding to requests from the Topology Object Model 24. The sequence begins when a topology agent 25 sends a query to an intelligent element in one of the domains being modeled by the Topology Object Model 24 (step 120). The intelligent element (or agent operating on behalf of the intelligent element) transmits the current status of the element back to the requesting topology agent 25 (step 122). Those skilled in the art will recognize that the status of the intelligent element may be provided by the intelligent element independent of a prior request from the topology agent 25 without departing from the scope of the present invention. In other words, the status update process may be synchronous or asynchronous. The status is compared to the status currently stored in an entity object associated with the responding element (step 124). A determination is made as to whether or not the status has changed (step 125). If the status has not changed the entity object status is left unchanged in the entity object (step 126). If the status of the element has changed from the status stored in the entity object, the status in the entity object is updated to reflect the current status (step 128). All of the referenced objects contained in the entity object are also updated to reflect the new status (step 130). Those skilled in the art will recognize that the use of an agent to transmit the status query is optional, and other dynamic methods of determining element status may be used without departing from the scope of the present invention.

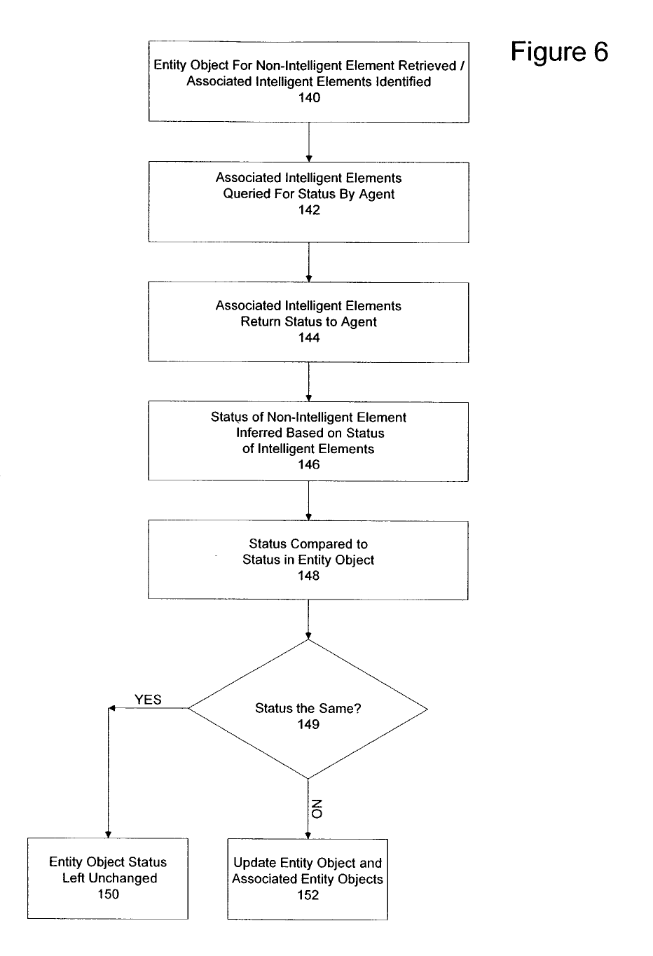

A similar updating process is followed to determine the status of non-intelligent elements present in the various domains. FIG. 6 depicts the sequence of steps followed by the illustrative embodiment of the present invention to determine and update the status of non-intelligent elements. The sequence begins by retrieving an entity object for a non-intelligent element from the Topology Object Model 24. Associated intelligent elements that are referenced in the entity object for the non-intelligent element are identified (step 140). The associated intelligent elements are queried to detect their status. (step 142). The associated intelligent elements return their status to the requesting topology agent 25 (step 144). The status of the non-intelligent element is then inferred based upon the status of the associated intelligent elements (step 146). For example, the status of an optical fiber may be inferred from the status of the two terminals at either end of the fiber. If both terminals are operating in good condition, the connecting fiber may be inferred to be operational. The inferred status is compared to the status recorded in the entity object for the non-intelligent element (step 148) and a determination is reached as to whether or not the status of the non-intelligent element has changed (step 149). If the status has not changed the entity object status recorded for the non-intelligent element is left unchanged in the entity object (step 150). Alternatively, if the status has changed, the entity object status is updated and any associated items referred to in the entity object are also updated to reflect the new status (step 152).

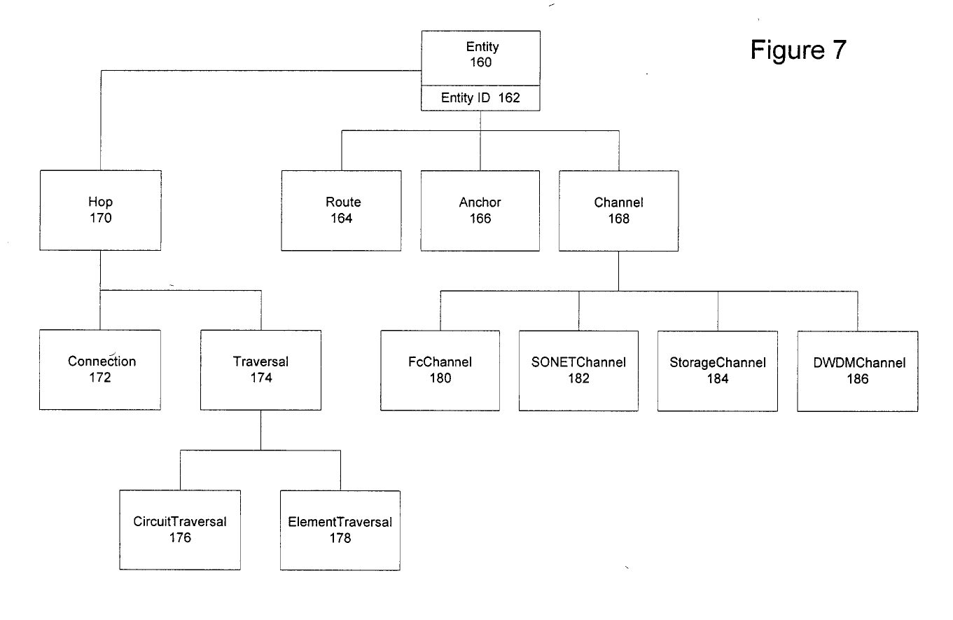

Entity objects include connectivity objects used to model the flow of data across domains. FIG. 7 depicts a block diagram of the connectivity object heirarchy. The connectivity object heirarchy is topped by an entity object 160 which is identified by a unique entity ID 162. The entity object 160 includes a route object 164, an anchor object 166, and a channel object 168. The route object 164 contains route information. A route is a datapath that is described as an ordered series of hops across one or more devices. The route is the aggregation of the ordered sequences of hops that realizes a datapath. The anchor object 166 is an object that represents the association between a channel and a device. An anchor represents a virtual partition of a device (i.e.: a port) where all data entering through that partition is mapped to the same destination within the logical element. In a SONET-based domain for example, an anchor represents a particular STS time slice mapping on a specific port (i.e.: an anchor is one end of a cross-connect). The channel object 168 includes information about one or more channels. A channel represents a domain specific property that differentiates individual connections within a multiplexed group of connections. In a DWDM-based domain, a channel is represented by a lambda, in a SONET-based domain, a channel is represented by an STS time slice. Fibre Channel channel object 180, SONET channel object 182, storage channel object 184 and DWDM channel object 186 all include domain specific connection property information.

The entity object 160 also includes a hop object 170. The hop object is an abstract object that encapsulates all device-to device connectivity. Hops have A-side and Z-side end points (devices). Hops are realized as either connections or traversals which are represented by connection objects 172 and traversal objects 174. Connection objects 172 contain information about connections. Connections are datapaths that are described as a collection of routes across one or more devices. The routes may be decomposed into their actual datapath or hops. Connections are associated with the services they provide (data divergence and convergence, load balancing, etc.). It is the aggregation of one or more routes encapsulated to provide path divergence and convergence. The routes within a connection may not necessarily converge to the same end point depending upon the connection type. Connections can be associated with applications and services via a circuit object. A traversal object 174 contains information about a traversal. A traversal is the abstract realization of a hop that allows for connectivity among devices. The traversal allows for the convergence or divergence of a datapath. A traversal represents a path between anchors. In a SONET-based domain for example, a traversal is the logical realization of a cross-connect. The traversal object 174 includes a circuit traversal object 176 and an element traversal object 178. The circuit traversal object 176 represents the realization of a circuit's path across the network in general, and a traversal or link in particular. For example, a circuit's datapath along a cabling between two DWDM elements, or the datapath within a cross-connect. The element traversal object 178 holds information about the physical elements used to transmit data across the domain.

The connectivity objects are used to produce a connectivity element model which provides a normalized object representation of logical elements. The topology of a network may be represented as a collection of connectivity elements, cables and links. The network topology may be used to build a graphical topology representation. The connectivity elements reference logical elements, circuits and applications and contain a mapping between the types of traversals it has (element and circuit traversals) and other traversal objects of that type. The connectivity objects are also used to build a connectivity object model. The connectivity object model is used to represent datapath connectivity across connectivity element objects. The connectivity element objects allow applications to be associated with their datapaths via the use of a circuit object.

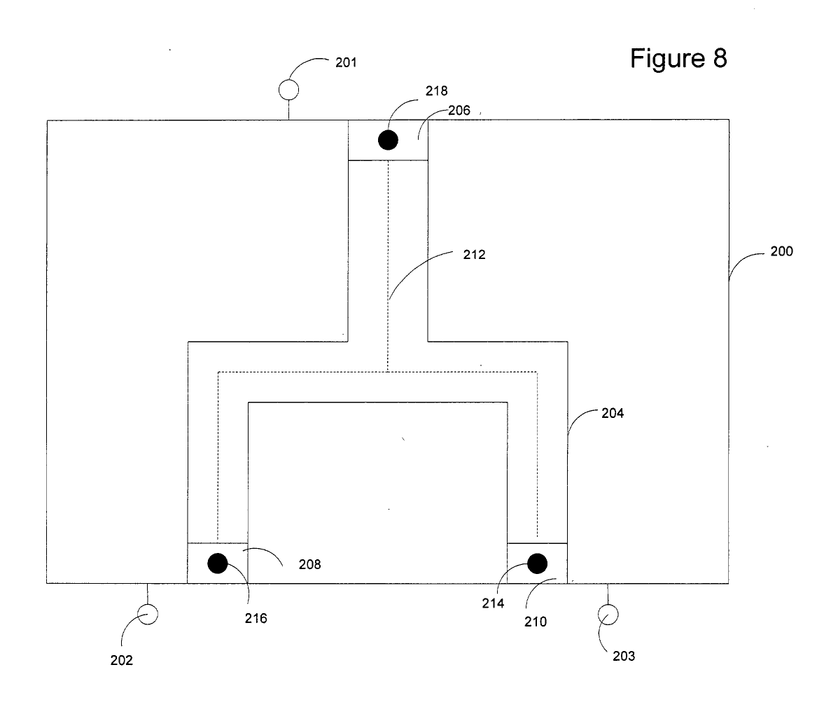

FIG. 8 depicts a block diagram of a connectivity element, a SONET network element 200. The information depicted is stored in the connectivity objects associated with the connectivity element. The SONET network element 200 is represented as having three ports 201, 202 and 203. Also shown is an element traversal 204 representing a provisioned data path, in this case, a UPSR-cross connect with STS-3c bandwidth. The sides of the element traversal 204 are defined by three element traversal anchors 206, 208 and 210. The element traversal depicted is divergent as it splits to end at two separate element traversal anchors 208 and 210. The data in the element traversal 204 travels from an A-side anchor 206 to a Z-side anchor 208 or 210. An element traversal's anchor represents a virtual slice of the port with a similar granularity as the cross-connect provisioned on the network element. In the depicted FIG. 8, each anchor's channel has a bandwidth of STS-3c.

Within the element traversal 204 is a circuit traversal 212. The circuit traversal 212 is the the realization of a specific application's data path as a sub-traversal across an existing element traversal. The circuit traversal ends in three circuit traversal anchors 214, 216 and 218. While the element traversal represents data flow within a network element based on the input ports and channels of the data, it does not have circuit awareness, rather it has network element provisioning (or configuration) awareness. Conversely, the circuit traversal has circuit awareness. A circuit traversal object is created for every discovered element traversal object and attached to a new connection object (which in turn is attached to a circuit object). The circuit traversal is configured to consume the full bandwidth of the element traversal by setting the circuit traversal anchor objects appropriately. Thus each provisioned data path across a network element is related to a circuit upon the discovery of the network element. When the element traversal is later connected to another element traversal (such as by cabling two ports together) the circuit traversals are joined by merging the parent route, connection and circuit objects. This results in two small circuits which spanned a single element being joined to form a single longer circuit spanning two elements. This behavior allows the connectivity information modeled by the illustrative embodiment of the presentation to be scalable. When a network element or cable is modified, reconfiguration is limited to the devices directly involved in the change and their associated objects (such as circuits traversing the device). When the topology object model 24 has fully discovered the environment, each end to end datapath is represented by a unique circuit object. A user may then associate specific applications with the circuits.

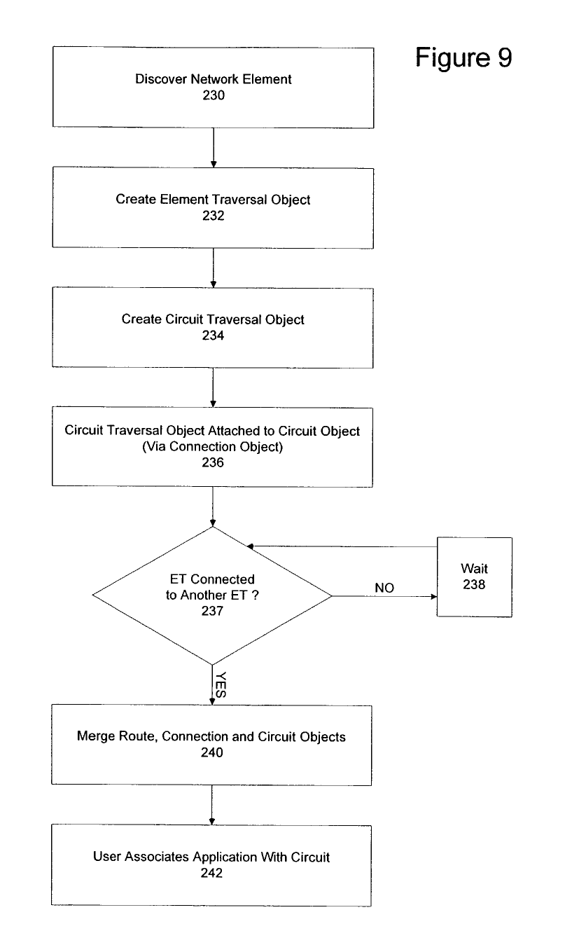

FIG. 9 is a flowchart of the sequence of steps followed by the illustrative embodiment of the present invention to dynamically extend circuits. The sequence begins with the discovery of a new network element (step 230). Upon the discovery of the network element, an element traversal object is created and associated with the element (step 232). A circuit traversal object is also created and associated with the element traversal object (step 234). The circuit traversal object is attached to a connection object which in turn is attached to a circuit object (step 236). The objects are stored in the topology object model 24. A determination is made by the topology object model 24 as to whether the element is connected to other elements (step 237). If there is not sufficient data to determine what other network elements the element is connected to, the topology object model waits and does not adjust the stored circuit object (step 238). If it is determined that the network element is connected to another element, the topology object model 24 merges the route connection and circuit objects of the two elements to create a longer datapath traversing both elements (step 240). A user may then associate an application with the newly extended circuit (step 242). Those skilled in the art will recognize that a user may associate an application with a stored circuit at any time in the sequence without departing from the scope of the present invention. The circuit maintains a 1:1 cardinality with a connection. Since an application may be represented by its own object which refers to the circuit object, changes in status to the circuit are mirrored to the application object.

It will thus be seen that the invention attains the objectives stated in the previous description. Since certain changes may be made without departing from the scope of the present invention, it is intended that all matter contained in the above description or shown in the accompanying drawings be interpreted as illustrative and not in a literal sense. For example, although reference is made for illustration purposes to the transfer of data across multiple types of domains between data centers, the illustrative embodiment of the present invention may be practiced without the presence of data centers without departing from the scope of the invention. Practitioners of the art will realize that the sequence of steps and architectures depicted in the figures may be altered without departing from the scope of the present invention and that the illustrations contained herein are singular examples of a multitude of possible depictions of the present invention.

We claim:

1. In a networked system with a plurality of different types of domains and a plurality of data centers, said data centers transmitting and receiving data across said domains, a method, comprising the steps of:
monitoring programmatically data flow between said data centers across said domains; and
storing indications of logical connections used in said data flow, said indications of logical connections detected by said monitoring.

2. The method of claim 1, comprising the further step of:
displaying a graphical representation of the logical connections used in said data flow to a user accessing said system.

3. The method of claim 1, comprising the further step of:
calculating programmatically end to end datapaths between said data centers, said datapaths utilizing said logical connections.

4. The method of claim 3, comprising the further step of:
displaying a graphical representation of an end to end datapath beween said data centers, said datapath utilizing said logical connections.

5. In a networked system with a plurality of different types of domains and a plurality of data centers, said data centers transmitting and receiving data across said domains, said domains populated with a plurality of elements, a method, comprising the steps of:
providing a plurality of entity objects wherein each entity object corresponds to and holds information about an element in one of said domains;
identifying elements in said plurality of domains; and
storing entity objects holding indications of logical connections for data flow between said data centers via said elements in a Topology Object Model.

6. The method of claim 5, comprising the further step of:
determining programmatically datapaths for data flow between said data centers via said elements using said logical connections.

7. The method of claim 6, comprising the further steps of:
determining physical connections between said elements; and
storing an indication of said physical connections in said entity objects.

8. The method of claim 7, comprising the further step of:
storing characteristics of said elements in said entity objects.

9. The method of claim 8, comprising the further steps of:
displaying to a user a graphical representation of at least a portion of said datapaths between said datacenters, said graphical representation generated from data stored in said Topology Object Model.

10. The method of claim 8, comprising the further steps of:
displaying to a user a graphical representation of said logical connections between said elements, said graphical representation generated from data stored in said Topology Object Model.

11. The method of claim 8, comprising the further steps of:
displaying to a user a graphical representation of said physical connections between said elements, said graphical representation generated from data stored in said Topology Object Model.

12. The method of claim 5, comprising the further step of:
forming an association between at least two of said elements, said associations stored in a corresponding entity object for each of said elements.

13. The method of claim 5 wherein said element is at least one of an electronic device, physical transport medium and application.

14. The method of claim 13 wherein said element is a collection of said elements.

15. The method of claim 5, comprising the further steps of:
querying said elements to determine said logical connections;
receiving a response to said query, said response indicating a status condition of said element;
updating the status of the responding element based on the results to said query, said updated status being stored in the entity object associated with the responding element; and
updating a logical connection stored in at least one entity object to reflect the updated status of said responding element.

16. The method of claim 5, comprising the further steps of:
querying at least one element associated with a target element to determine said logical connections, said target element being an element lacking the ability to respond to a query;
receiving a response to said query from said at least one element associated with said target element, said response indicating a status condition of said at least one element;
inferring the condition of said target element based upon said response from said at least one element associated with said target element;
updating the status of said target element based on the response to said query, said updated status being stored in the entity object associated with said target element; and
updating a logical connection stored in at least one entity object to reflect the updated status of said target element.

17. The method of claim 5 wherein said plurality of different domains include at least two of a Synchronous Optical Network-based (SONET) domain, a DWDM-based (Dense Wave Division Multiplexing) domain, a Storage Area Network-based (SAN) domain, a server-based domain, a storage-based domain, a Channel Extension-based domain, a Mainframe-based domain, an Application-based domain, and an IP/Ethernet-based domain.

18. A networked system for providing cross-domain awareness, comprising:
a plurality of electronic devices, said electronic devices transmitting and receiving data across a plurality of domains, including at least two of a Synchronous Optical Network-based (SONET) domain, a DWDM-based (Dense Wave Division Multiplexing) domain, a Storage Area Networking-based (SAN) domain, a server-based domain, a storage-based domain, a Channel Extension-based domain, a Mainframe-based domain, an Application-based domain, and an IP/Ethernet-based domain; and
a Topology Object Model holding a plurality of entity objects, each said entity object corresponding to and holding information about an element in one of said domains, said entity object model determining programmatically logical connections for data flow across said domains, said data flow traveling between said electronic devices via said elements, said logical connections recorded in said entity objects.

19. The system of claim 18 wherein said logical connections are graphically displayed to a user accessing said networked system.

20. In a networked system with a plurality of different types of domains and a plurality of data centers, said domains populated with a plurality of elements, said data centers transmitting and receiving data across said domains, a medium holding computer-executable instructions for a method, said method comprising the steps of:
providing a plurality of entity objects wherein each entity object corresponds to and holds information about an element in one of said domains;
identifying elements in said plurality of domains;
storing entity objects holding indications of logical connections for data flow between said data centers via said elements in a Topology Object Model.

21. The medium of claim 20, wherein at least one of said logical connections and said physical connections are programmatically determined.

22. The medium of claim 20 wherein said method comprises the further steps of:
displaying to a user a graphical representation of at least one of said logical connections and physical connections between said elements, said graphical representation generated from data stored in said Topology Object Model.

23. The medium of claim 20 wherein said plurality of domains are at least two of a Synchronous Optical Network-based (SONET) domain, a DWDM-based (Dense Wave Division Multiplexing) domain, a Storage Area Networking-based (SAN) domain, a server-based domain, a storage-based domain, a Channel Extension-based domain, a Mainframe-based domain, an Application-based domain, and an IP/Ethernet-based domain.

24. The medium of claim 20 wherein said method comprises the further step of:
forming an association between at least two of said elements, said association stored in a corresponding entity object for each of said elements.

25. The medium of claim 20 wherein said method comprises the further steps of:
determining said logical connections by querying one of said elements;
receiving a response to said query, said response indicating a status condition of said element;
updating the status of the responding element in the entity object corresponding to the responding element; and
updating a logical connection stored in at least one entity object to reflect the status of said responding element.

26. In a networked system with a plurality of different types of domains, said domains populated with a plurality of elements, a method, comprising the steps of:
providing a plurality of entity objects wherein each entity object corresponds to and holds information about an element in one of said domains;
identifying elements in said plurality of domains;
storing entity objects holding indications of logical connections for data flow between said elements in a Topology Object Model; and
associating an application element with at least one datapath, said association being stored in the corresponding entity object for said application element and said datapath.

27. The method of claim 26, comprising the further step of:
updating the entity object corresponding to said application element in response to a change in status in said datapath associated with said application element.

28. The method of claim 26, comprising the further step of:
determining programmatically said logical connections for data flow between said elements.

29. The method of claim 28, comprising the further steps of:
determining programmatically end to end datapaths for data flow between said elements using said logical connections.

30. In a networked system with a plurality of different types of domains, said domains populated with a plurality of elements, said elements transmitting and receiving data across said domains, a method, comprising the steps of:
providing a plurality of entity objects wherein each entity object corresponds to and holds information about an element in one of said domains;
identifying programmatically said elements in said plurality of domains;
storing entity objects holding indications of datapaths for data flow between said elements in a Topology Object Model.

31. The method of claim 30, comprising the further steps of:
displaying a graphical representation of said datapaths to a user accessing said networked system.
